(19) United States
(12) Patent Application Publication
(10) Pub. No.: US 2015/0195274 A1
(43) Pub. Date: Jul. 9, 2015

(54) SYSTEM AND METHOD OF CERTIFICATING A GENUINE ARTICLE

(71) Applicant: SEMISYSCO CO., LTD., Suwon (KR)

(72) Inventors: Soon-Jong Lee, Seoul (KR); Dong-Seok Lee, Seoul (KR); Hak-Kwon Kim, Hwaseong (KR)

(73) Assignee: SEMISYSCO CO., LTD.

(21) Appl. No.: 14/590,858

(22) Filed: Jan. 6, 2015

(30) Foreign Application Priority Data
Jan. 6, 2014 (CN) 201410005801.7
Dec. 22, 2014 (KR) 10-2014-0185937

(51) Int. Cl. H04L 29/06; H04W 12/06

(52) U.S. Cl. CPC H04L 63/0823; H04W 12/06

(57) ABSTRACT

A method for authenticating a genuine article includes: performing a first authentication by comparing authentication information of an article, transmitted from an authentication terminal, with previously stored authentication information; and performing a second authentication by deciding whether an authentication check device of the article is replicated. Here, genuine article authentication is completed when both the first authentication and the second authentication are completed.

### CROSS-REFERENCE TO RELATED APPLICATION

This application claims priority to Chinese Patent Application No. 201410005801.7 filed on Jan. 6, 2014 and Korean Patent Application No. 10-2014-0185937 filed on Dec. 22, 2014, which applications are incorporated herein by reference.

### TECHNICAL FIELD

The present invention relates to a system and a method for authenticating a genuine article.

### BACKGROUND ART

In general, when a customer purchases an article, the customer desires to check whether the corresponding article is a genuine article. Particularly, when a customer purchases a high-class, high-priced article such as a famous branded product or worldwide luxury product, an antique or a hand-made product, the customer's desire to check whether the corresponding article is a genuine article is very strong.

Meanwhile, a manufacturer has taken various measures for authenticating that its own articles are genuine articles in order to prevent other manufacturers from copying and distributing its own articles and to enable customers to trust its own articles.

In order to prevent imitation of an article, a manufacturer provides articles with a specific identification means (a trademark, a hologram, a telephone check code, or the like) being marked thereon, but forged articles that copy not only the external appearance of the corresponding articles but also the identification means of the corresponding articles are distributed. For this reason, there is a problem in that general customers have difficulty in distinguishing the genuine articles from the forged articles with their appearances without any help of a specialist.

Therefore, in a method for authenticating a genuine article using a mark, logo or the like, the mark, logo or the like may be copied or used by stealth no matter how it is elaborated and special.

Accordingly, it is required to develop a highly reliable system and method capable of authenticating a genuine article.

### SUMMARY

An aspect of the present invention is directed to a system and a method for authenticating a genuine article by performing a first authentication through an authentication number of a tag of an article and a second authentication through decision of replication of the article.

Another aspect of the present invention is directed to a system and a method for authenticating a genuine article, which have reinforced security.

According to an embodiment of the present invention, a method for authenticating a genuine article includes: performing a first authentication by comparing authentication information of an article, transmitted from an authentication terminal, with previously stored authentication information; and performing a second authentication by deciding whether an authentication check device of the article is replicated, wherein genuine article authentication is completed when both the first authentication and the second authentication are completed.

According to another embodiment of the present invention, an authentication server used in a system for authenticating a genuine article includes: a communication unit connected to an authentication terminal; and an authentication unit configured to primarily authenticate whether an article is a genuine article by comparing authentication information transmitted from the authentication terminal with previously stored authentication information, and secondarily authenticate whether the article is the genuine article by checking whether an authentication check device of the article is replicated.

According to still another embodiment of the present invention, an authentication terminal used in a system for authenticating a genuine article includes: a communication unit configured to act as a connection channel with an authentication server; and an authentication unit configured to transmit, to the authentication server, authentication request signal including authentication information acquired from an authentication check device, and receive, from the authentication server, a genuine article authentication result according to the transmitted authentication request signal, wherein the genuine article authentication result is a result of a first authentication through the authentication information and a second authentication through decision of replication.

According to still another embodiment of the present invention, an authentication terminal connected to an authentication server includes: an identification unit configured to identify an authentication check device; and an authentication unit configured to transmit, to the authentication server, an authentication number transmitted from the authentication check device, and transmit, to the authentication check device, a security key transmitted from the authentication server, as the transmitted authentication number corresponds to an authentication number stored in the authentication server, wherein, if authentication information acquired by the security key is received from the authentication check device, the authentication unit performs genuine article authentication based on the reception of the authentication information.

According to still another embodiment of the present invention, an authentication server connected to the authentication terminal includes: a communication unit configured to act as a connection channel with the authentication terminal; a storage unit configured to store authentication numbers; and an authentication unit configured to receive an authentication number from the authentication terminal, and perform a first authentication by comparing the received authentication number with a corresponding authentication number stored in the storage unit, wherein, when the first authentication is completed, the authentication unit transmits a security key to the authentication terminal.

According to still another embodiment of the present invention, a method for authenticating a genuine article in an authentication check device includes: transmitting an authentication number to an authentication terminal; receiving a security key from the authentication terminal; comparing the received security key with a security key stored in the authentication check device; acquiring authentication information in the authentication check device, when the security keys correspond to each other as the comparison result; and transmitting the acquired authentication information to the authentication terminal.

### BRIEF DESCRIPTION OF DRAWINGS

The above and other aspects, features and advantages of certain exemplary embodiments of the present invention will be more apparent from the following description taken in conjunction with the accompanying drawings, in which:

FIG. 1 is a view illustrating a system for authenticating a genuine article according to an embodiment of the present invention;

FIG. 2 is a flowchart illustrating a method for authenticating a genuine article according to a first embodiment of the present invention;

FIG. 3 is a view illustrating screens on which authentication results are displayed according to an embodiment of the present invention;

FIG. 4 is a flowchart illustrating a method for authenticating a genuine article according to a second embodiment of the present invention;

FIG. 5 is a view illustrating a screen on which an authentication result is displayed according to another embodiment of the present invention;

FIG. 6 is a flowchart illustrating a method for authenticating a genuine article according to a third embodiment of the present invention;

FIG. 7 is a flowchart illustrating a method for authenticating a genuine article according to a fourth embodiment of the present invention;

FIG. 8 is a flowchart illustrating a method for authenticating a genuine article according to a fifth embodiment of the present invention;

FIG. 9 is a flowchart illustrating a method for authenticating a genuine article according to a sixth embodiment of the present invention;

FIG. 10 is a view illustrating a process of identifying a tag according to an embodiment of the present invention;

FIG. 11 is a view illustrating a system for authenticating a genuine article by using authentication numbers according to an embodiment of the present invention;

FIG. 12 is a flowchart illustrating a method for authenticating a genuine article according to a seventh embodiment of the present invention;

FIG. 13 is a block diagram illustrating a configuration of an authentication terminal according to an embodiment of the present invention; and

FIG. 14 is a block diagram illustrating a configuration of an authentication server according to an embodiment of the present invention.

### DETAILED DESCRIPTION

Exemplary embodiments of the present invention will be described below in detail with reference to the accompanying drawings. Wherever possible, the same reference numerals will be used to refer to the same elements throughout the specification, and a duplicated description thereof will be omitted. It will be understood that although the terms “first”, “second”, etc. are used herein to describe various elements, these elements should not be limited by these terms. These terms are only used to distinguish one element from another element.

The present invention provides a system for authenticating a genuine article, which authenticates whether an article is a genuine article by using a near field communication technology.

According to an embodiment, the system of the present invention may authenticate whether an article is a genuine article by performing a first authentication through comparison of authentication information of an NFC tag adhered to the corresponding article and a second authentication for checking replication of the corresponding article.

For example, in a case where an authentication number (ID) identified from a tag adhered to an article corresponds to that registered by a manufacturer of the article, conventional systems authenticate that the article is a genuine article. In a case where the tag is replicated, an article requested to authenticate whether it is a genuine article may be a replicated article, but the conventional systems cannot check whether the article is replicated. As a result, the reliability of genuine article authentication is lowered.

Thus, the system of the present invention performs not only a first authentication through comparison of the authentication numbers but also a second authentication for deciding whether the article is a replicated article. As a result, a purchaser of the article does not purchase a replicated article but can purchase only a genuine article, and the reliability among manufacturers, sellers and customers can be improved.

According to another embodiment, the system of the present invention performs genuine article authentication having reinforced security. Particularly, the system of the present invention has the reinforced security and simultaneously simplifies the entire genuine article authenticating process, thereby optimizing the system. Thus, it is possible to reduce the time required to authenticate a genuine article.

For example, the system of the present invention may authenticate a genuine article by using a first authentication number registered by a chip manufacturer and a second authentication number registered by a system provider.

Hereinafter, exemplary embodiments of a system and a method for authenticating a genuine article according to the present invention will be described with reference to the accompanying drawings.

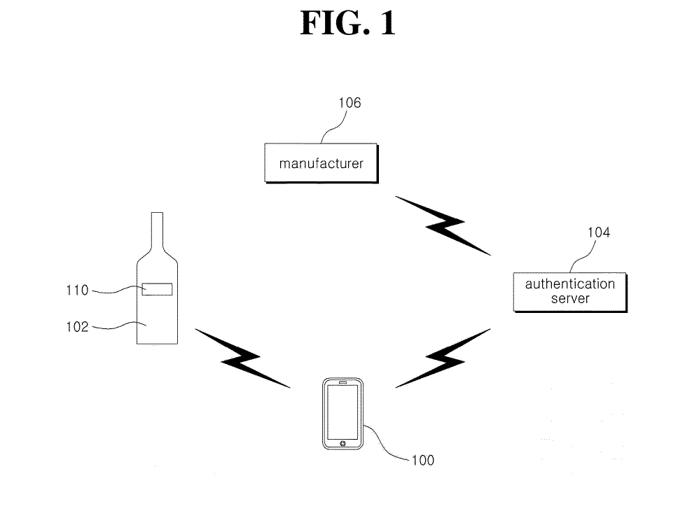

FIG. 1 is a view illustrating a system for authenticating a genuine article according to an embodiment of the present invention.

Referring to FIG. 1, the system according to this embodiment may include an authentication terminal 100, an authentication server 104 and a manufacturer 106.

An authentication check device including an authentication number, e.g., a tag 110 may be adhered to a portion of an article 102 to be authenticated, e.g., an article such as wine.

According to an embodiment, the tag 110 may be an NFC tag, and may include a manufacturer name, a manufacturing data, a manufacturing number, an authentication number for genuine article authentication, and the like. The tag 110 may be made of aluminum, synthetic resin, paper or the like. The tag 110 may be encoded using a security key. The authentication terminal 100 is a terminal for performing an authentication process. The authentication terminal 100 may be generally a terminal owned by a seller selling the article 102 or a terminal owned by a customer purchasing the article 102, e.g., a smart phone.

According to an embodiment, the authentication terminal 100 includes an NFC chip, and may identify the tag 110 adhered to the article 102 using the NFC chip. For example, the authentication terminal 100 may read information on an authentication number, i.e., authentication information, from the tag 100.

Meanwhile, in addition to the NFC technique, the authentication terminal 100 and the tag 110 may be connected through various wireless communication techniques, particularly a near field wireless communication technique. However, hereinafter, it will be assumed that, for convenience of illustration, the authentication terminal 100 and the tag 110 are connected through the NFC technique.

The authentication terminal 100 transmits, to the authentication server 104, an authentication request signal including an authentication number identified from the tag 110 and/or an identification number (e.g., a serial number, a MAC address, or the like) of the authentication terminal 100, and may display an authentication result transmitted from the authentication server 104.

According to an embodiment, an authentication application may be installed in the authentication terminal 100. The authentication terminal 100 may acquire authentication information from the tag 110 under control of the authentication application in a state in which the authentication application is executed, and transmit, to the authentication server 104, an authentication request signal including the acquired authentication information. Meanwhile, the authentication terminal 100 may encode the authentication request signal with hash codes or the like and then transmit the encoded authentication request signal to the authentication server 104.

The authentication server 104 may be connected to the authentication terminal 100 and a terminal of the manufacturer 106 (hereinafter, referred to as a “manufacturer terminal”), and perform genuine article authentication.

According to an embodiment, the authentication server 104 may compare an authentication number included in the authentication request signal transmitted from the authentication terminal 100 with a previously stored authentication number, thereby performing a first authentication when the authentication numbers correspond to each other. Then, the authentication server 104 may check whether the article 102 is a replicated article, thereby performing a second authentication.

For example, there may occur a replication environment such as a case where the tag 110 adhered to the article 102 is a replica of a tag adhered to another article or a case where a replicated tag is adhered to another article. Thus, if the same authentication number as the authentication number read from the tag 102 is transmitted from another terminal to the authentication server 104, i.e., if a genuine article authentication request using the same authentication number is transmitted from a plurality of authentication terminals to the authentication server 104, the authentication server 104 can decide the article 102 as a replicated article.

Meanwhile, the replication environment may be divided into two cases, i.e., a first case where different authentication numbers are provided to the same kind of articles, respectively, and a second case where the same authentication number is provided to the same kind of articles.

In the first case, the authentication server 104 may decide that an article is a replicated article when the same authentication number is transmitted from different authentication terminals, and transmit, to all the terminals, an authentication signal for notifying that the genuine article authentication of the corresponding article fails. For example, although luxury bags are the same kind of bags, different authentication numbers may be set to all the luxury bags, respectively. In this case, if the authentication server 104 receives requests of genuine article authentication from a plurality of authentication terminals using the same authentication number, the authentication server 104 may decide that replication has occurred.

According to another embodiment, the authentication server 104 may transmit a genuine article authenticating signal for notifying that an article has been authenticated as a genuine article to an authentication terminal first transmitting an authentication number, and transmit an authentication fail signal for notifying that the genuine article authentication has failed to an authentication terminal transmitting an authentication number subsequently received from the authentication server 104.

In the second case, if the number of authentication numbers received from authentication terminals, i.e., the number of authentication requests through the same authentication number, is smaller than a predetermined number, the authentication server 104 may transmit, to the corresponding authentication terminals, a genuine article authenticating signal for notifying that an article has been authenticated as a genuine article. If the number of authentication requests is not less than the predetermined number, the authentication server 104 may transmit, to the corresponding authentication terminals, an authentication fail signal for notifying that the genuine article authentication has failed. For example, in a case where 1000 wines are manufactured using the same authentication number, if the number of authentication requests from authentication terminals is smaller than 1000, the authentication server 104 may decide that the wines has been authenticated as genuine articles. If the number of authentication requests from authentication terminals is not less than 1000, the authentication server 104 may decide that replication has occurred.

If the replication is checked, the authentication server 104 may transmit, to the authentication terminal 100, an authentication fail signal for notifying that the genuine article authentication has failed, and transmit information that it is required to check the replication to a manager's terminal or the manufacturer terminal.

In conclusion, the system of this embodiment can authenticate that the article 102 is a genuine article when the article 102 passes through both the first authentication through the comparison of the authentication number identified from the tag 110 and the second authentication for checking replication. Thus, the system can accurately decide whether the article 102 is a genuine article, and a purchaser can purchase the article 102 while trusting that the article 102 is a genuine article. Accordingly, the reliability among the manufacturer, the seller and the purchaser can be improved.

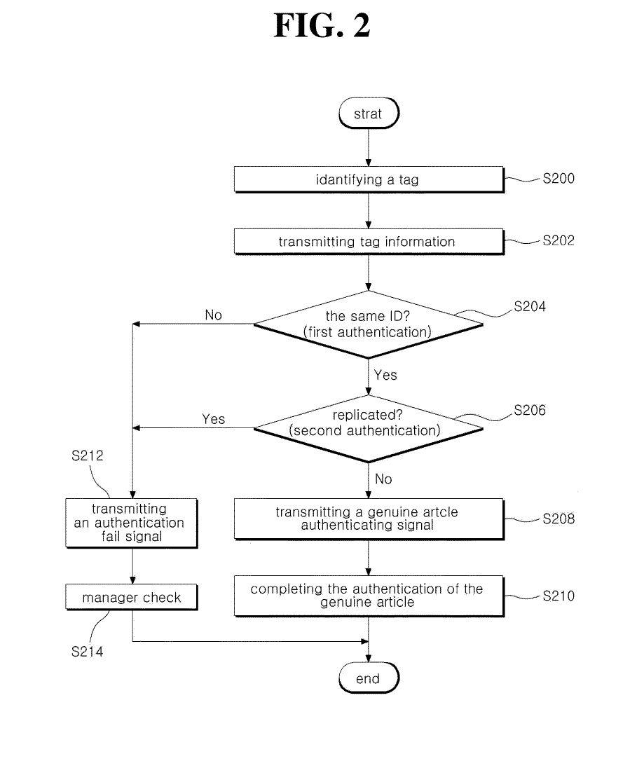

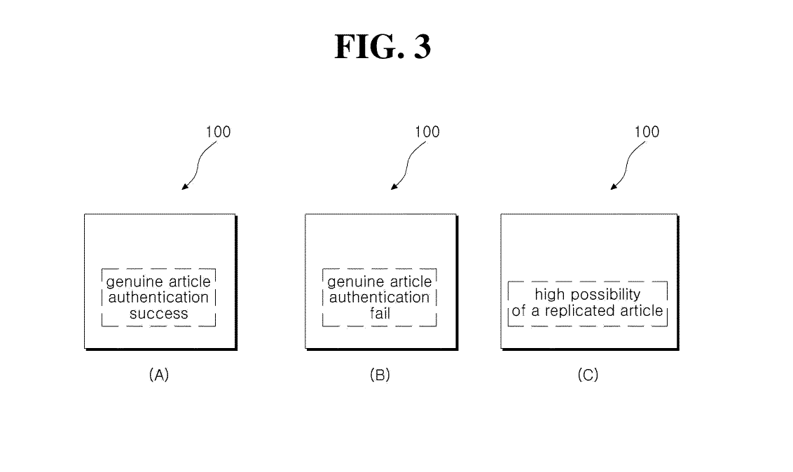

FIG. 2 is a flowchart illustrating a method for authenticating a genuine article according to a first embodiment of the present invention. FIG. 3 is a view illustrating screens on which authentication results are displayed according to an embodiment of the present invention.

Referring to FIG. 2, the authentication terminal 100 identifies the tag 110 adhered to the article 102 (S200). Specifically, the authentication terminal 100 includes, for example, an NFC chip, and may read tag information (authentication information) including an authentication number from the tag 110 using the NFC chip.

According to an embodiment, an authentication application may be installed in the authentication terminal 100. If a user executes the authentication application and then allows the authentication terminal 100 to approach or touch the tag 110, the authentication terminal 100 may read the tag information from the tag 110.

Subsequently, the authentication terminal 100 may transmit, to the authentication server 104, tag information, particularly an authentication request signal including the authentication number and an identification number of the authentication terminal 100 (S202). According to an embodiment, the authentication terminal 100 may encode the authentication request signal and transmit the encoded authentication request signal to the authentication server 104. The encoding method is not limited.

Continuously, the authentication server 104 decides whether the authentication number extracted from the transmitted authentication request signal corresponds to a previously stored authentication number (S204). According to an embodiment, the authentication server 104 may previously store an authentication number registered for each article.

If the authentication numbers do not correspond to each other, the authentication server 104 may transmit, to the authentication terminal 100, an authentication fail signal that has information that genuine article authentication has failed (S212), and transmit, to a manager, the information that the genuine article authentication has failed (S214). However, step S214 may be omitted.

On the other hand, if the authentication numbers correspond to each other, the authentication server 104 completes a first authentication, and decides whether the article 102 is a replicated article, i.e., whether the tag 110 adhered to the article 102 is replicated (S206).

According to an embodiment, in a case where the authentication server 104 receives authentication request signals including the same authentication number from a plurality of authentication terminals 100, the authentication server 104 may decide that the tag 110 has been replicated. In this case, steps S212 and S214 may be performed. Particularly, if it is decided that replication has occurred, the authentication server 104 may provide a manager or manufacturer with a message that the replication has occurred, thereby executing a program capable of preventing any subsequent replication. This will be described in detail later.

If it is decided that the article 102 is not a replicated article, the authentication server 104 may decide that the article 102 is a genuine article, thereby completing a second authentication. The authentication server 104 may transmit, to the authentication terminal 100, a genuine article authenticating signal having the decision result (S208).

The authentication terminal 100 may identify that the article 102 is the genuine article through the transmitted genuine article authenticating signal (S210), and display the identification result.

A method of displaying success or fail of genuine article authentication will be described. As shown in (A) of FIG. 3, a message, i.e., “genuine article authentication success,” that the genuine article authentication has succeeded, may be displayed through the authentication terminal 100.

In a case where the genuine article authentication fails, e.g., in a case where the article 102 is not authenticated as the genuine article in the first or second authentication, as shown in (B) of FIG. 3, a message, i.e., “genuine article authentication fail,” that the genuine article authentication has failed, may be displayed through the authentication terminal 100.

In a case where the first authentication has been completed, but the article 102 is not authenticated as the genuine article in the second authentication, as shown in (C) of FIG. 3, a message, i.e., “genuine article authentication fail (high possibility of a replicated article)” may be displayed through the authentication terminal 100.

That is, the system of the present invention may display different messages for situations of the genuine article authentication through the authentication terminal 100.

According to another embodiment, in a case where the authentication terminal 100 is the terminal of the seller selling the article 102, a message with respect to the genuine article authentication may be transmitted to the purchaser's terminal to be displayed.

In conclusion, in the method of this embodiment, the article 102 can be authenticated as the genuine article only when the article 102 passes through the first authentication through the authentication number and the second authentication through the check of replication.

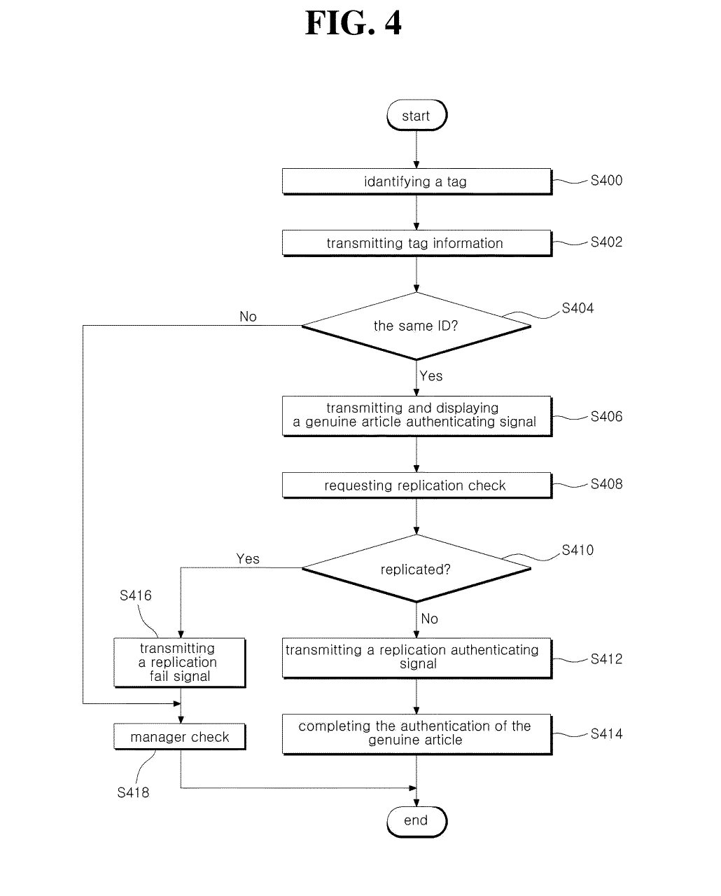

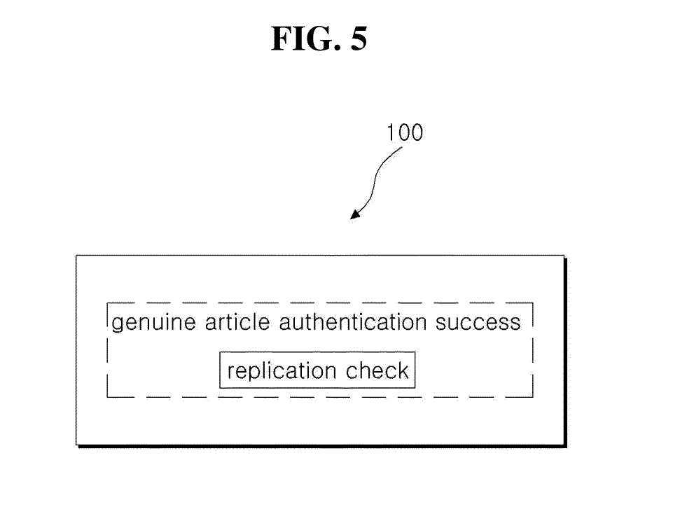

FIG. 4 is a flowchart illustrating a method for authenticating a genuine article according to a second embodiment of the present invention. FIG. 5 is a view illustrating a screen on which an authentication result is displayed according to another embodiment of the present invention.

Referring to FIG. 4, the authentication terminal 100 acquires tag information including an authentication number by identifying the tag 110 adhered to the article 102 (S400).

Subsequently, the authentication terminal 100 may transmit, to the authentication server 104, the tag information, particularly an authentication request signal including the authentication number and an identification number of the authentication terminal 100 (S402).

Continuously, the authentication server 104 decides whether the authentication number extracted from the transmitted authentication request signal corresponds to a previously stored authentication number (S404).

If the authentication numbers do not correspond to each other, the authentication server 104 may transmit, to the authentication terminal 100, an authentication fail signal having information that the genuine article authentication has failed, and transmit, to the manager, the information that the genuine article authentication has failed (S418). However, step S418 may be omitted.

On the other hand, if the authentication numbers correspond to each other, the authentication server 104 may decide that the genuine article authentication has been primarily completed, and transmit, to the authentication terminal 100, a genuine article authenticating signal having the decision result. The authentication terminal 100 may display a message that the article 102 has been authenticated as a genuine article according to the transmitted genuine article authenticating signal (S406).

For example, the authentication terminal 100, as shown in FIG. 5, displays a message, i.e., “genuine article authentication success.” Since the check of replication is not performed, the authentication terminal 100 may display a “replication check” user interface (UI) through which a replication check can be requested. The display of the UI may be variously modified.

Subsequently, if the user selects the “replication check” UI through the authentication terminal 100, the authentication terminal 100 may transmit the replication check to the authentication server (S408).

Continuously, the authentication server 104 decides whether the article 102 is a replicated article, i.e., whether the tag 110 adhered to the article 102 is replicated (S410).

In a case where it is decided that the article 102 is the replicated article, the authentication server 104 may transmit, to the authentication terminal 100, a replication fail signal including information that the article 102 has been replicated (S416).

Subsequently, the authentication server 104 may transmit, to a manager and/or a manufacturer, information that the replication has occurred (S418).

On the other hand, in a case where it is decided that the replication has not occurred, the authentication server 104 may transmit a replication authenticating signal to the authentication terminal 100 (S412), and the authentication terminal 100 may display information that the article 102 has been finally authenticated as the genuine article according to the transmitted replication authenticating signal (S414).

In conclusion, in the method of this embodiment, the first authentication is completed through the authentication number, and the replication can be checked only when the user requests the replication check.

According to another embodiment, in the method, the first authentication is completed through the authentication number, and the replication can be automatically checked after a predetermined time elapses after the first authentication.

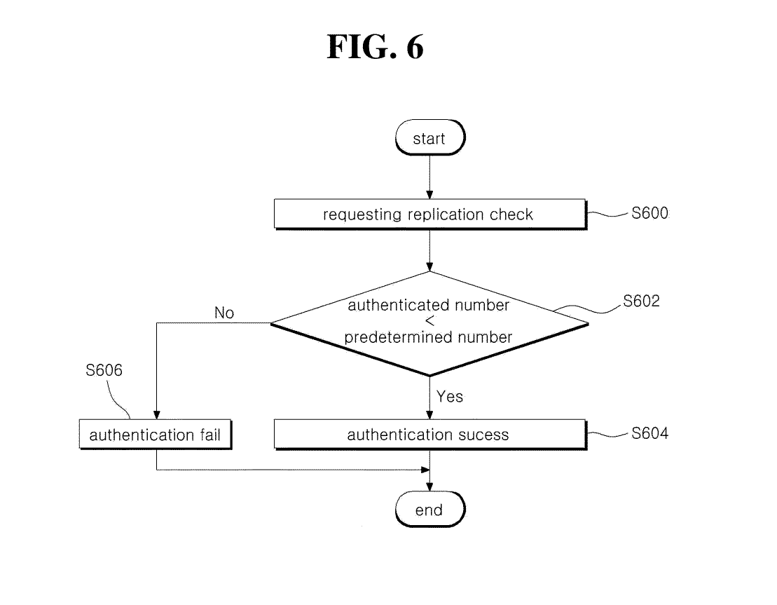

FIG. 6 is a flowchart illustrating a method for authenticating a genuine article according to a third embodiment of the present invention.

Referring to FIG. 6, after the first authentication is completed, the authentication terminal 100 may request the authentication server 104 of a replication check (S600).

Subsequently, the authentication server 104 decides whether the number of authentication requests requested from external terminals including the authentication terminal 100 that have the same authentication number or the number of authentication performances is smaller than a predetermined number (S602). Hereinafter, the number of authentication requests or the number of authentication performances will be commonly referred to as an “authenticated number.” For example, the authentication server 104 may decide whether the authenticated number is smaller than 60 times per minute and/or 1200 times per hour. That is, the authentication server 104 may decide whether the authenticated number is smaller than a predetermined time per hour.

In a case where the authenticated number is smaller than the predetermined time, the authentication server 104 may decide that, since there occurs no replication, the genuine article authentication has succeeded, and transmit, to the authentication terminal 100, a genuine article authenticating signal having the decision result. The authentication terminal 100 may display a message that the genuine article authentication has succeeded according to the transmitted genuine article authenticating signal (S604).

On the other hand, in a case where the authenticated number is not less than the predetermined number, the authentication server 104 may decide that, since replication occurs, the genuine article authentication has failed, and transmit, to the authentication terminal 100, an authentication fail signal having the decision result. The authentication terminal 100 may display a message that the genuine article authentication has failed according to the transmitted authentication fail signal (S606).

In conclusion, in the method of this embodiment, the replication can be decided through the authenticated number. It will be apparent that, in the case where it is decided that the replication has occurred, the authentication server 104 may provide the manager or the manufacturer with information that the replication has occurred.

The above-described method can be efficient when the same authentication number is provided to the same article.

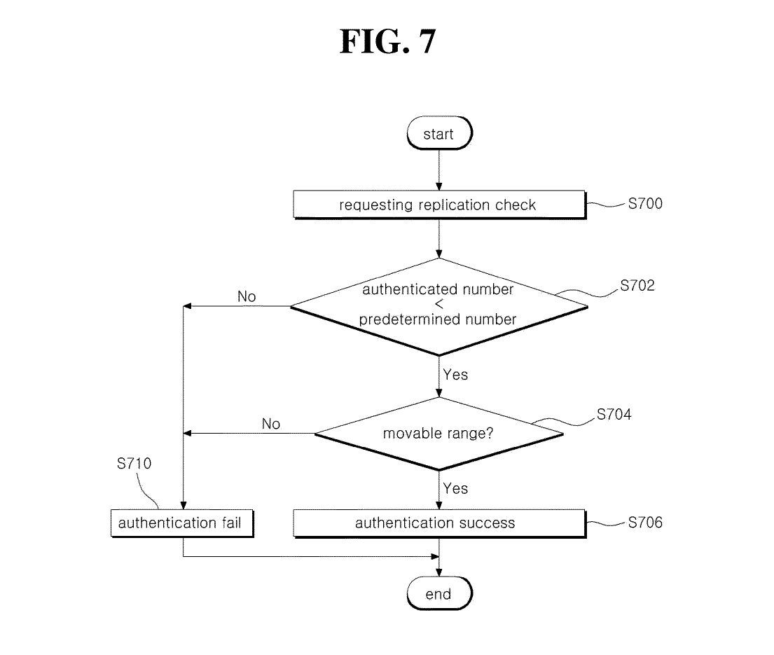

FIG. 7 is a flowchart illustrating a method for authenticating a genuine article according to a fourth embodiment of the present invention.

Referring to FIG. 7, after the first authentication is completed, the authentication terminal 100 may request the authentication server 104 of a replication check (S700).

Subsequently, the authentication server 104 decides whether the number of authentication requests requested from external terminals including the authentication terminal 100 that have the same authentication number or the number of authentication performances is smaller than a predetermined number (S702). Hereinafter, the number of authentication requests and the number of authentication performances will be commonly referred to as an “authenticated number.” In a case where the authenticated number is not less than the predetermined number, the authentication server 104 may decide that replication has occurred, and transmit, to the authentication terminal 100, an authentication fail signal having the decision result. The authentication terminal 100 may display a message that the genuine article authentication has failed according to the transmitted authentication fail signal (S710).

On the other hand, in a case where the authenticated number is smaller than the predetermined number, the authentication server 104 decides whether the tag 110 receiving an authentication request is located in a movable time (S704). Specifically, since there is a case where the genuine article authentication is again tried on the tag 110 already subjected to the genuine article authentication after a predetermined time, the authentication server 104 compares the position of the tag 110 receiving a new authentication request with the position of the tag 110 in the previous genuine article authentication, and decides whether the movement time of the tag 110, corresponding to the distance based on the comparison result, is within a movable range.

Meanwhile, in order to perform the method, when the authentication terminal 100 identifies the tag 110, the authentication terminal 100 is to acquire not only an authentication number but also location information of the tag 110. The authentication terminal 100 transmits the authentication number and the location information to the authentication server 104. Meanwhile, the location information is not the location information of the tag 110 but may be location information of the authentication terminal 100.

If the tag 110 is located in the movable time, the authentication server 104 may decide that the genuine article authentication has succeeded, and transmit a genuine article authenticating signal to the authentication terminal 100.

On the other hand, if the tag 110 is not located in the movable time, the authentication server 104 may decide that the genuine article authentication has failed, and transmit the authentication fail signal to the authentication terminal 100.

In conclusion, in the method of this embodiment, replication can be decided by performing a plurality of authentication processes.

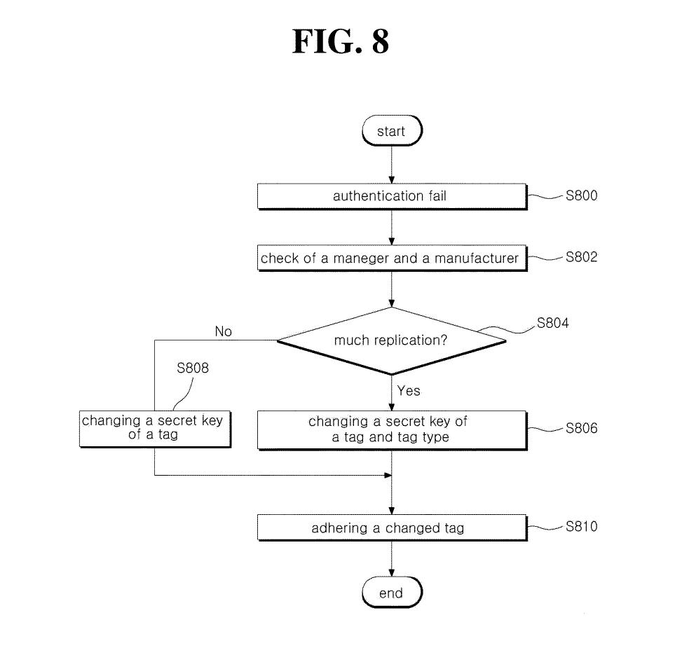

FIG. 8 is a flowchart illustrating a method for authenticating a genuine article according to a fifth embodiment of the present invention.

Referring to FIG. 8, in a case where it is decided the genuine article authentication has failed, particularly in a case where it is decided that replication has occurred (S800), the authentication server 104 may provide the decision result to a manager and/or a manufacturer (S802).

The manager or the manufacturer may decide whether the number of replications is not less than a predetermined number (S804). It will be apparent that step S804 may be performed by the authentication server 104.

In a case where the number of replications is smaller than the predetermined number, the manager or the manufacturer may change a security key of the tag 110 (S808), and adhere, to a corresponding article, the tag 110 encoded with the changed security key (S810). According to another embodiment, the authentication server 104 may determine to change the security key of the tag 110.

In a case where the number of replications is smaller than the predetermined number, the manager or the manufacturer may change not only the security key of the tag 110 but also a type of the tag 110 (S806), and adhere, to the corresponding article, the tag 110 having the changed security key and the changed type (S810). According to another embodiment, the authentication server 104 may determine to change the security key of the tag 110 and the type of the tag 110.

In conclusion, in the method of this embodiment, it is possible to perform a function of changing a tag when the genuine article authentication fails.

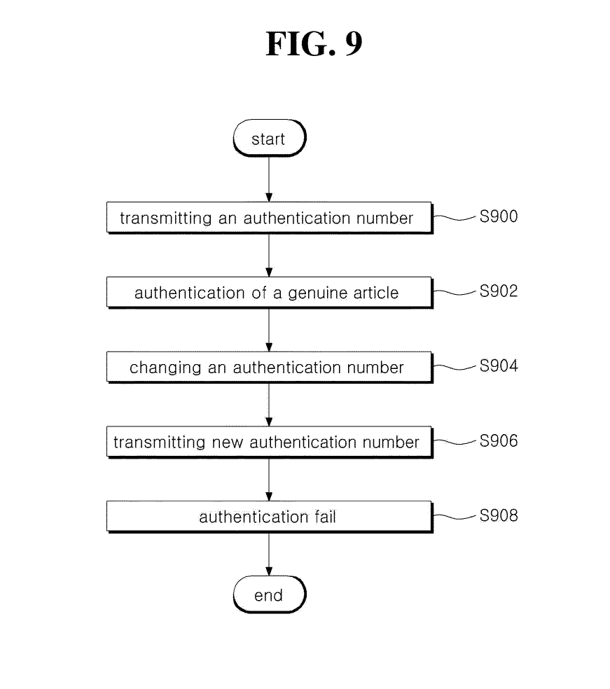

FIG. 9 is a flowchart illustrating a method for authenticating a genuine article according to a sixth embodiment of the present invention.

Referring to FIG. 9, the authentication terminal 100 transmits, to the authentication server 104, an authentication number read from the tag 110 and an identification number of the authentication terminal 100 (S900).

Subsequently, the authentication server 104 compares the transmitted authentication number with a previously stored authentication number (already registered authentication number). If the authentication numbers correspond to each other as the comparison result, the authentication server 104 authenticates an article as a genuine article (S902).

According to another embodiment, when an article passes through the first authentication through the authentication number and the second authentication for checking replication of the article, the authentication server 104 may authenticate the article as a genuine article.

Continuously, if the article is authenticated as the genuine article once, the authentication server 104 may change the previously stored authentication number (S904). For example, the previously stored authentication number may be changed from “1234” to “1234-1.”

Subsequently, in a case where a new authentication number is transmitted from another terminal to the authentication server 104 (S906), the authentication server 104 may compare the transmitted authentication number with the changed authentication number. Since the authentication numbers do not correspond to each other, the authentication server 104 may determine that the genuine article authentication has failed (908).

In conclusion, in the method of this embodiment, if the genuine article authentication succeeds once, the authentication number is changed. As a result, the authentication number is changed even though replication of the authentication number is made, and hence the genuine article authentication fails. That is, if the genuine article authentication is completed once, subsequent replication can be prevented.

According to another embodiment, after the genuine article authentication is completed through the first authentication and the second authentication, the authentication server 104 may store the previously stored authentication number and a number obtained by changing the previously store authentication number.

Subsequently, in a case where the genuine article authentication of the tag 110 is again requested at a location within the movable range, the authentication server 104 may authenticate the article as the genuine article by comparing the previously stored authentication number with the authentication number transmitted from the authentication terminal 100.

On the other hand, in a case where the genuine article authentication of the tag 110 is again requested at a location beyond the movable range, the authentication server 104 may determine that the genuine article authentication has failed by comparing the changed authentication number with the authentication number transmitted from the authentication terminal 100.

According to still another embodiment, if the genuine article authentication is completed once, the authentication server 104 may change an authentication number. If an authentication request signal including an authentication number identical to a previously stored authentication number is received from the authentication terminal 100 in the genuine article authentication, the authentication server 104 may determine that the genuine article authentication has succeeded by comparing the authentication number with the previously stored authentication number. If the authentication request signal including the authentication number identical to the previously stored authentication number is received from another terminal, the authentication server 104 may determine that the genuine article authentication has failed.

In the above, the genuine article authenticating process through the second authentication has been described. However, hereinafter, a genuine article authenticating process having reinforced security will be described.

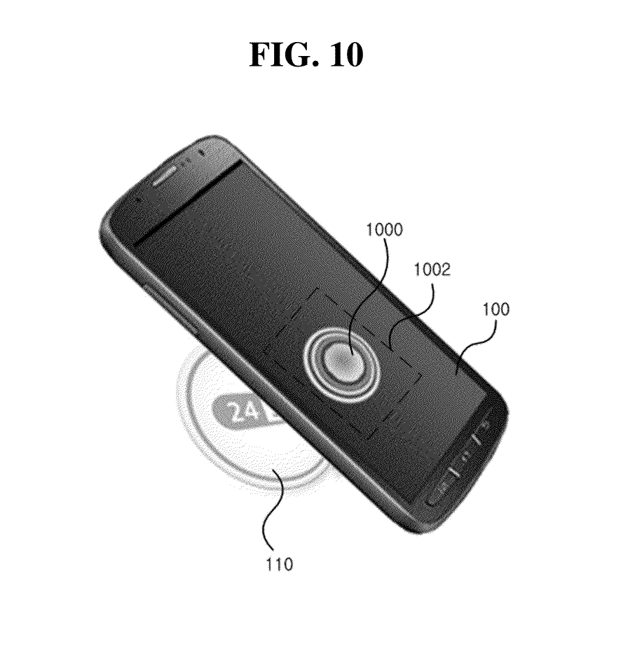

FIG. 10 is a view illustrating a process of identifying a tag according to an embodiment of the present invention.

Referring to FIGS. 1 and 10, the system according to this embodiment may include an authentication terminal 100, an authentication server 104 and a manufacturer 106.

An authentication check device, e.g., a tag 110 may be adhered to a portion of an article 102 to be authenticated, e.g., an article such as wine.

According to an embodiment, the tag 110 may be an NFC tag, and may include a manufacturer name, a manufacturing data, a manufacturing number, authentication numbers for genuine article authentication, and the like.

The authentication terminal 100 may transmit, to the authentication server 104, an authentication request signal including a first authentication number identified from the tag 110 and/or an identification number (e.g., a serial number, a MAC address, or the like) of the authentication terminal 100, and transmit, to the tag 110, a security key transmitted from the authentication server 104.

According to an embodiment, an authentication application may be installed in the authentication terminal 100. The authentication terminal 100 may acquire authentication information from the tag 110 in a state in which the authentication application is executed, and transmit, to the authentication server 104, an authentication request signal including the acquired authentication information.

The authentication terminal 100 may transmit, to the tag 110, the security key transmitted from the authentication server 104.

The authentication server 104 may be connected to the authentication terminal 100 and a terminal of the manufacturer 106 (hereinafter, referred to as a “manufacturer terminal”). The authentication server 104 performs a first authentication by comparing the first authentication number with a previously stored authentication number.

According to an embodiment, if the first authentication is completed by the authentication server 104, the authentication terminal 100 performs a second authentication by communicating with the tag 110. If the second authentication is completed, the authentication terminal determines that the article 102 has been authenticated as a genuine article.

In conclusion, the system of this embodiment performs not only the first authentication through comparison of the authentication number identified from the tag 110 but also the second authentication for reinforcing security, and determines that, when the second authentication is completed, the genuine article authentication has succeeded. Particularly, the genuine article authentication is finally determined by the authentication terminal 100, but is not determined by the authentication server 104. Thus, the system can perform the genuine article authentication while reinforcing the security. Further, the entire genuine article authenticating process can be simplified, thereby optimizing the system.

Meanwhile, as shown in FIG. 10, a tag identification location object 1000 may be displayed on a portion of a screen of the authentication terminal 100, so that an error does not occur when the tag 110 is identified using the authentication terminal 100.

Generally, the location of an antenna of the authentication terminal 100, e.g., a smart phone is changed depending on a manufacturer or a type of device. Therefore, any identification error does not occur only when a portion corresponding to the antenna in the authentication terminal 100 directly faces the tag 110. Otherwise, it is highly likely that an error will occur.

Accordingly, in the system of the present invention, a portion corresponding to an antenna for each type of terminal (hereinafter, referred to as an “antenna portion” 1002) is registered and stored in the authentication server 104 or a separate server.

If the authentication terminal 100 executes an application for genuine article authentication, the application may identify the antenna portion 1002 by asking, for example, the separate server for the type of the authentication terminal 100, and display the tag identification location object 1000 at the antenna portion 1002. Thus, a user can allow the authentication terminal 100 to appropriately face the tag 110 based on the tag identification location object 1000. As a result, any tag identification error cannot occur. It will be apparent that the authentication terminal 100 may store information on the tag identification location object 1000, and the tag identification location object 1000 may be displayed on the screen of the authentication terminal 100 in the identification of the tag.

Meanwhile, when the authentication terminal 100 does not identify the tag 110, the authentication terminal 100 may display information that the tag has not been identified and/or information that the authentication terminal 100 is to directly face the tag 110 at an appropriate location.

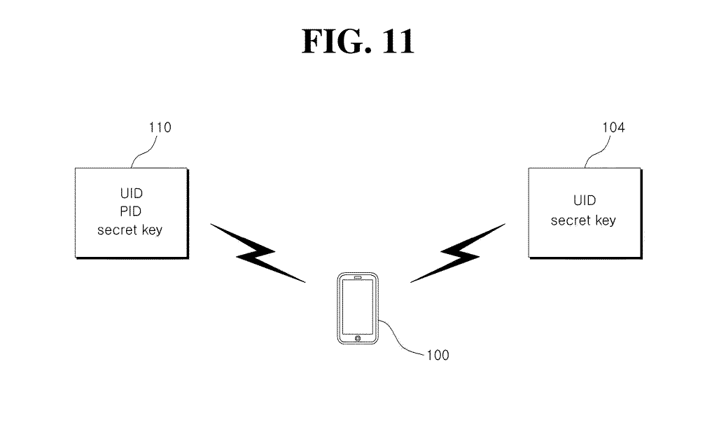

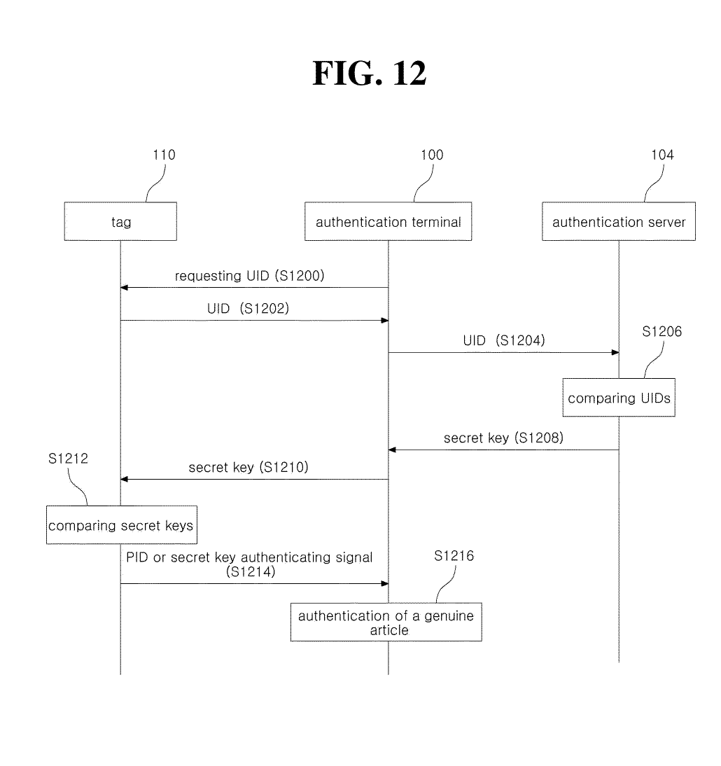

FIG. 11 is a view illustrating a system for authenticating a genuine article by using authentication numbers according to an embodiment of the present invention. FIG. 12 is a flowchart illustrating a method for authenticating a genuine article according to a seventh embodiment of the present invention.

Referring to FIG. 11, a tag 110 may store a first authentication number, e.g., a UID that is a number given by a manufacturer of the tag, a second authentication number, e.g., a PID that is a number given by a provider of the system, and a security key. An authentication server 104 may store a UID and a security key. In this instance, an authentication terminal 100 does not store a UID, a PID and a security key, but may have a function of distinguishing the UID, the PID and the security key.

Meanwhile, the PID is a kind of authentication information, and the authentication information may be implemented in various forms including a letter, a character, an image and the like, rather than the form of a number. In this case, the tag 110 may include a UID, authentication information and a security key, and the authentication server 104 may include a UID and a security key.

The UID may be changed for each tag 110. However, the PID may be changed for each tag 110, and some tags 110 may share the same PID. The reason why some tags 110 may share the same PID is that the PID is read by only a security key as will be described later, and the security key is changed for each tag 110.

Hereinafter, for convenience of illustration, the first and second authentication numbers will be referred to as UID and PID, respectively.

Referring to FIGS. 11 and 12, a user may execute an authentication application of the authentication terminal 100 and then request the tag 110 of a UID using the authentication terminal 100 (S1200). In this instance, the tag identification location object 1000 may be displayed on a screen of the authentication terminal 100. Thus, the user can allow the authentication terminal 100 to be exactly located on the tag 110 so that the identification of the tag 110 is possible.

Subsequently, the tag 110 may transmit a UID to the authentication terminal 100 according to the request (S1202). In this instance, the UID is encoded with hash codes or the like and then transmitted to the authentication terminal 100.

Continuously, the authentication terminal 100 may transmit, to the authentication server 104, the transmitted UID together with an identification number of the authentication terminal 100 (S1204).

Subsequently, the authentication server 104 may compare the transmitted UID with a UID that the authentication server 104 stores (S1206).

If the UIDs do not correspond to each other as the comparison result, the authentication server 104 may transmit, to the authentication terminal 100, authentication fail information that the UIDs do not correspond to each other. The authentication terminal 100 may display information that genuine article authentication has failed.

On the other hand, if the UIDs correspond to each other as the comparison result, the authentication server 104 may transmit a security key to the authentication terminal 100 (S1208).

Continuously, the authentication terminal 100 transmits the transmitted security key to the tag 110 (S1210).

Subsequently, the tag 110 may compare the transmitted security key with a security key stored in the tag 110 (S1212).

If the security keys correspond to each other, the tag 110 may read a PID stored in the tag 110 using the security key, and transmit the read PID to the authentication terminal 100 (S1214). According to another embodiment, the tag 110 may transmit, to the authentication terminal 100, a security key authenticating signal for notifying that, instead of the PID, the security keys correspond to each other.

In this case, the authentication terminal 100 may authenticate an article to which the tag 110 is adhered as a genuine article according to the transmitted PID or the security key authentication signal, and may display, on the screen, information that the genuine article authentication has succeeded (S1216).

On the other hand, if the security keys do not correspond to each other, the PID is not read, and therefore, the tag 110 may not transmit any information to the authentication terminal 100. If the PID is not received from the tag 110 until a predetermined time elapses after the security key is transmitted to the tag 110, the authentication terminal 100 may display, on the screen, information that the genuine article authentication has failed.

In conclusion, in the method of this embodiment, the first authentication is performed through comparison of UIDs that are first authentication numbers, and the second authentication is then performed using PIDs. Thus, an article can be finally authenticated as a genuine article only when the second authentication is completed.

Particularly, the authentication terminal 100 authenticates an article as a genuine article when simply receiving a PID from the tag 110, and does not compare PIDs. Thus, in the method, the genuine article authenticating process can be simplified while reinforcing security by using security keys and PIDs.

It will be apparent that the genuine article authentication may be completed after the authentication terminal 100 compares PIDs. However, the genuine article authenticating process is complicated, and the time required to perform genuine article authentication is delayed. In addition, the load of the authentication terminal 100 may increase.

As another example, the genuine article authentication may be completed after the authentication terminal 100 transmits a PID to the authentication server 104, and the authentication server 104 compares PIDs. However, the time required to perform the genuine article authentication may be considerably delayed.

Meanwhile, in the above, the tag 110 has transmitted a PID to the authentication terminal 100. However, the tag 110 may transmit, to the authentication terminal 100, authentication information, instead of the PID. As the authentication terminal 100 receives the authentication information, the authentication terminal 100 may authenticate an article as a genuine article.

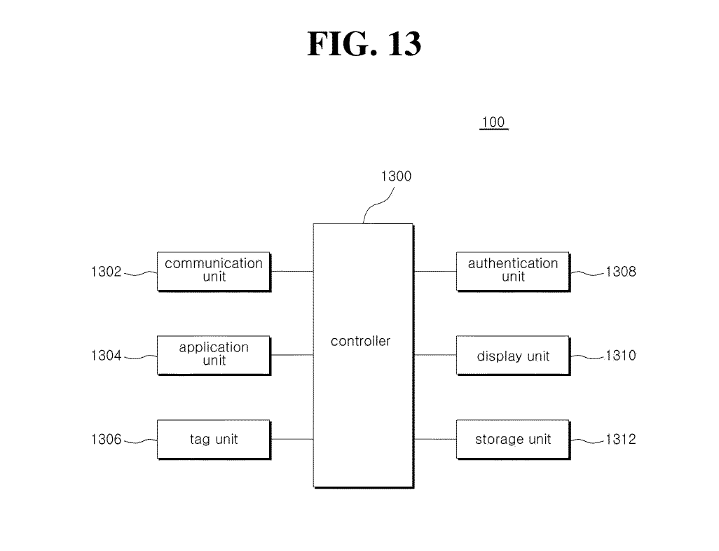

FIG. 13 is a block diagram illustrating a configuration of an authentication terminal according to an embodiment of the present invention.

Referring to FIG. 13, the authentication terminal 100 may include a controller 1300, a communication unit 1302, an application unit 1304, a tag unit (identification unit) 1306, an authentication unit 1308, a display unit 1310 and a storage unit 1312.

The communication unit 1302 acts as a connection channel between a tag 110 and an authentication server 104. For example, the communication unit 1302 and the tag 110 may be connected through near field communication, and the communication unit 1302 and the authentication server 104 may be connected through 4G communication or the like, instead of the near field communication.

The application unit 1304 manages an authentication application for performing genuine article authentication, and the authentication application is installed in the authentication terminal 100. Here, the authentication application may be an application originally installed in the authentication terminal 100, or an application installed by being downloaded from a specific server.

According to an embodiment, in the method of the present invention, the application may control a tag chip, and a genuine article authenticating process may be performed in a state in which the application is executed.

The tag unit 1306 performs all operations related to the tag 110. As an example, the tag unit 1306 may acquire authentication number and/or location information from the tag 110. As another example, the tag unit 1306 may acquire a UID, a PID and/or location information from the tag 110.

The authentication unit 1308 performs all operations related to the genuine article authentication. For example, the authentication unit 1308 may transmit a genuine article request signal to the authentication server 104, and receive a genuine article authentication result from the authentication server 104.

As another example, if authentication information including, for example, a PID is transmitted from the tag 110, the authentication unit 1308 may authenticate an article as a genuine article.

The display unit 1310 displays information, UI, etc. The display unit 1310 may display an authentication result or UI, i.e., “replication check” under control of the authentication unit 1308. The display unit 1310 is not limited, including an OLED, an LCD, a PDP and the like.

The storage unit 1312 may store various data including a program for the application, an authentication result, information acquired from the tag 110, and an identification number of the authentication terminal 100, and the like.

The controller 1300 may control all operations of the components of the authentication terminal 100.

Although not described above, the authentication terminal 100 may further include a UI unit for managing various types of UIs including a replication check UI, and the like.

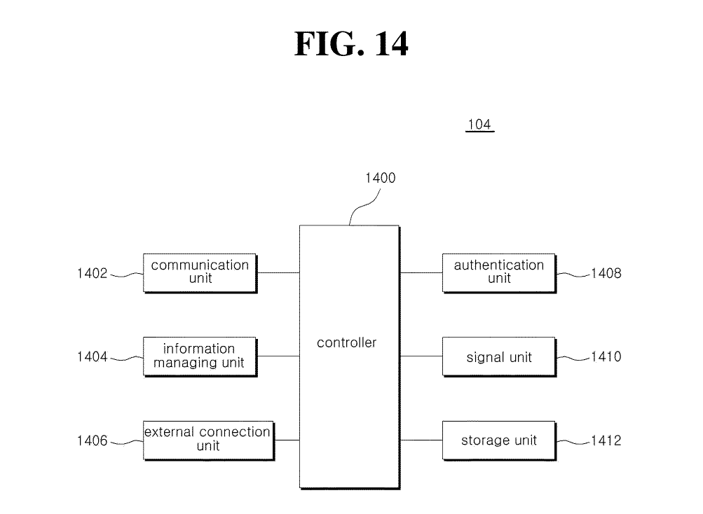

FIG. 14 is a block diagram illustrating a configuration of an authentication server according to an embodiment of the present invention.

Referring to FIG. 14, the authentication server 104 of this embodiment may include a controller 1400, a communication unit 1402, an information managing unit 1404, an external connection unit 1406, an authentication unit 1408, a signal unit 1410 and a storage unit 1412.

The communication unit 1402 acts as a connection channel between an authentication terminal 100 and a manager's terminal or manufacturer's terminal.

The information managing unit 1404 stores and manages an article and an authentication number corresponding to the article, which are previously registered, for the purpose of genuine article authentication. The information managing unit 104 may register and store authentication numbers for the genuine article authentication, e.g., a UID and a security key.

The external connection unit 1406 manages connection between external terminals such as the authentication terminal 100 and the manager's terminal or manufacturer's terminal.

The authentication unit 1408 performs a first authentication through comparison of an authentication number transmitted from the authentication terminal 100 with a previously stored authentication number, and performs a second authentication through decision of replication. The authentication unit 1408 decides whether the genuine article authentication has succeeded or failed through the first authentication and the second authentication.

According to another embodiment, the authentication unit 1408 may perform a first authentication through comparison of a UID transmitted from the authentication unit 100 with a previously stored UID, and may transmit a security key to the authentication terminal 100 when the first authentication is completed.

The signal unit 1410 may transmit, to the authentication terminal 100, an authentication signal (genuine article authenticating signal or authentication fail signal) having the genuine article authentication result, or may transmit a signal for notifying replication to the manager or the manufacturer.

According to another embodiment, the signal unit 1410 may transmit a signal including the security key to the authentication terminal 100.

The storage unit 1412 may store various data including information on an article, an authentication number, a program, an authentication result, and the like.

The controller 1400 may control all operations of the components of the authentication server 104.

Although not described above, the authentication server 104 may further include a tag changing unit.

The tag changing unit may decide whether the number of replications after the second authentication is smaller than a predetermined number. If the number of replications is smaller than the predetermined number, the tag changing unit may determine the security key of the tag as the authentication check device to be changed. If the number of replications is greater than the predetermined number, the tag changing unit may determine the security key of the tag and the type of the tag to be changed.

According to the system and the method of the present invention, an article is authenticated as a genuine article only when a first authentication through an authentication number of a tag and a second authentication through decision of replication are completed. As a result, it is possible to improve the reliability of the genuine article authentication.

Further, according to the system and the method of the present invention, a first authentication through an authentication number and a second authentication using a security key and a PID are performed, and thus the security of genuine article authentication can be reinforced. Particularly, an authentication terminal authenticates an article as a genuine article based on the reception of a PID, and thus the entire authenticating process can be simplified while reinforcing the security. As a result, it is possible to reduce the time required to perform the genuine article authentication.

While the invention has been shown and described with reference to exemplary embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

1. A method for authenticating a genuine article, the method comprising:
performing a first authentication by comparing authentication information of an article, transmitted from an authentication terminal, with previously stored authentication information; and
performing a second authentication by deciding whether an authentication check device of the article is replicated,
wherein genuine article authentication is completed when both the first authentication and the second authentication are completed.

2. The method of claim 1, wherein the authentication check device is an NFC tag adhered to the article, and the authentication information is an authentication number read from the tag, and
wherein the second authentication is performed after the first authentication is completed, and the first authentication and the second authentication are performed by an authentication server.

3. The method of claim 1, further comprising:
transmitting, to the authentication terminal, information that the genuine article authentication has primarily succeeded when the first authentication is completed;
receiving a replication check request from the authentication terminal; and
transmitting, to the authentication terminal, a result of the second authentication according to the replication check request.

4. An authentication server used in a system for authenticating a genuine article, the authentication server comprising:
a communication unit connected to an authentication terminal; and
an authentication unit configured to primarily authenticate whether an article is a genuine article by comparing authentication information transmitted from the authentication terminal with previously stored authentication information, and secondarily authenticate whether the article is the genuine article by checking whether an authentication check device of the article is replicated.

5. The authentication server of claim 4, further comprising a signal unit,
wherein the authentication check device is an NFC tag, and the authentication information is an authentication number of the tag, and
wherein, when genuine article authentication fails in the first authentication or the second authentication, the signal unit transmits, to the authentication terminal, information that the genuine article authentication has failed, and when the first authentication and the second authentication are completed, the signal unit transmits, to the authentication terminal, information that the genuine article authentication has succeeded.

6. The authentication server of claim 4, wherein the authentication unit decides whether the number of authentication requests requested from external authentication terminals or the number of authentication performances, is smaller than a predetermined number, determines that the replication has occurred when the authenticated number is not less than the predetermined number, and determines that the replication has not occurred when the authenticated number is smaller than the predetermined number.

7. The authentication server of claim 4, wherein the authentication unit decides whether the number of authentication requests requested from external authentication terminals or the number of authentication performances is smaller than a predetermined number, decides whether the authentication check device is located in a movable time by comparing previous location information of the authentication check device with current location information of the authentication check device when the authenticated number is smaller than the predetermined number, determines that the replication has not occurred when the authentication check device is located in the movable time, and determines that the genuine article authentication has failed when the authenticated number is not less than the predetermined number or when the authentication check device is not located in the movable time.

8. The authentication server of claim 4, further comprising a tag changing unit configured to decide whether the number of replications is smaller than a predetermined number after the second authentication is completed, determine a security key of a tag as the authentication check device to be changed when the number of replications is smaller than the predetermined number, and determine the security key of the tag and the type of the tag to be changed when the number of replications is greater than the predetermined number.

9. An authentication terminal used in a system for authenticating a genuine article, the authentication terminal comprising:
a communication unit configured to act as a connection channel with an authentication server; and
an authentication unit configured to transmit, to the authentication server, authentication request signal including authentication information acquired from an authentication check device, and receive, from the authentication server, a genuine article authentication result according to the transmitted authentication request signal,
wherein the genuine article authentication result is a result of a first authentication through the authentication information and a second authentication through decision of replication.

10. The authentication terminal of claim 9, further comprising a tag unit configured to acquire the authentication information from an authentication check device adhered to an article,
wherein the authentication check device is an NFC tag, and the authentication information is an authentication number of the tag.

11. The authentication terminal of claim 9, further comprising a display unit,
wherein the authentication unit receives a result of the first authentication from the authentication server, and displays the received result of the first authentication on the display unit, and
wherein a replication check UI is displayed on the display unit, and if a user selects the replication check UI, the authentication unit transmits a replication check request to the authentication server.

12. The authentication terminal of claim 9, further comprising an application unit configured to execute an authentication application,
wherein the authentication unit acquires the authentication information from a tag of an article in a state in which the authentication application is executed, and transmits, to the authentication server, an authentication request signal including the acquired authentication information.

13. An authentication terminal connected to an authentication server, the authentication terminal comprising:
an identification unit configured to identify an authentication check device; and
an authentication unit configured to transmit, to the authentication server, an authentication number transmitted from the authentication check device, and transmit, to the authentication check device, a security key transmitted from the authentication server, as the transmitted authentication number corresponds to an authentication number stored in the authentication server,
wherein, if authentication information acquired by the security key is received from the authentication check device, the authentication unit performs genuine article authentication based on the reception of the authentication information.

14. The authentication terminal of claim 13, wherein the authentication check device is an NFC tag, the authentication number is a number (UID) given by a manufacturer of the tag, and the authentication information is a number (PID) given by a provider of a system for authenticating a genuine article, and
wherein the UID and the security key are changed for each tag, and the PID is commonly used in a plurality of tags or differently used for each tag.

15. The authentication terminal of claim 13, further comprising an application unit configured to execute an application for genuine article authentication,
wherein the authentication terminal performs the genuine article authentication based on the reception of the authentication information without comparing the authentication information.

16. The authentication terminal of claim 13, wherein an object indicating a position where the identification of the authentication check device is possible is displayed on a screen of the authentication terminal, and
wherein the object corresponds to the position of an antenna of the authentication terminal.

17. An authentication server connected to the authentication terminal of claim 13, the authentication server comprising:
a communication unit configured to act as a connection channel with the authentication terminal;
a storage unit configured to store authentication numbers; and
an authentication unit configured to receive an authentication number from the authentication terminal, and perform a first authentication by comparing the received authentication number with a corresponding authentication number stored in the storage unit,
wherein, when the first authentication is completed, the authentication unit transmits a security key to the authentication terminal.

18. A method for authenticating a genuine article in an authentication check device, the method comprising:
transmitting an authentication number to an authentication terminal;
receiving a security key from the authentication terminal;
comparing the received security key with a security key stored in the authentication check device;
acquiring authentication information in the authentication check device, when the security keys correspond to each other as the comparison result; and
transmitting the acquired authentication information to the authentication terminal.

19. The method of claim 18, wherein the authentication check device is an NFC tag, the authentication number is a number (UID) given by a manufacturer of the tag, and the authentication information is a number (PID) given by a provider of a system for authenticating a genuine article, and
wherein the UID and the security key are changed for each tag, the PID is commonly used in a plurality of tags or differently used for each tag, and the PID is read by only the security key.
